(19) United States
(12) Patent Application Publication
(10) Pub. No.: US 2007/0048452 A1
(43) Pub. Date: Mar. 1, 2007

(54) Apparatus and method for field-injection electrostatic spray coating of medical devices

(76) Inventors: James Feng, Maple Grove, MN (US); James Lee Shippy III, Plymouth, MN (US); Bruce Forsyth, Hanover, MN (US)

Correspondence Address: KENYON & KENYON LLP, 1500 K STREET N.W., SUITE 700, WASHINGTON, DC, 20005, US

(21) Appl. No.: 11/216,181

(22) Filed: Sep. 1, 2005

(51) Int. Cl. B05D 1/04; H05C 1/00; B05B 5/025

(52) U.S. Cl. 427/458; 118/621

(57) ABSTRACT

An apparatus and method for field-injection electrostatic spray deposition of medical devices like stents. The apparatus includes a medical device holder, which applies a first electrical potential to the medical device, and an electrically insulative electrostatic spray dispensing device having an electrically conductive electrode, which applies a second electrical potential, creating an electrical potential difference sufficient to attract charged coating material particles emitted from an orifice of the dispensing device toward the medical device. The electrode may be sharpened to create a localized, high-strength electric field to improve the charge injection into the coating material or coating solution.

### FIELD OF THE INVENTION

The field of the present invention is application of coatings to medical devices, such as stents. More specifically, the present invention is directed to the field of electrostatic spraying of a fluid, such as a therapeutic fluid, to apply a coating to a medical device.

### BACKGROUND

Medical implants are used for innumerable medical purposes, including the reinforcement of recently re-enlarged lumens, the replacement of ruptured vessels, and the treatment of disease such as vascular disease by local pharmacotherapy, i.e., delivering therapeutic drug doses to target tissues while minimizing systemic side effects. Such localized delivery of therapeutic agents has been proposed or achieved using medical implants which both support a lumen within a patient's body and place appropriate coatings containing absorbable therapeutic agents at the implant location. Non-limiting examples of such medical devices include catheters, guide wires, balloons, filters (e.g., vena cava filters), stents, stent grafts, vascular grafts, intraluminal paving systems, implants and other devices used in connection with drug-loaded polymer coatings. Such medical devices are implanted or otherwise utilized in body lumina and organs such as the coronary vasculature, esophagus, trachea, colon, biliary tract, urinary tract, prostate, brain, lung, liver, heart, skeletal muscle, kidney, bladder, intestines, stomach, pancreas, ovary, cartilage, eye, bone, and the like. The medical devices can be structures that are designed to be left in the body or vasculature to support body lumina and organs. One example of such permanent structures can be a metallic coronary stent, which is designed to be permanently placed within coronary vessels for vessel support and to resist degradation. Other permanent non-degradable structures may be made from ceramic composite or other polymeric materials.

The delivery of expandable stents is a specific example of a medical procedure that may involve the deployment of coated implants. Expandable stents are tube-like medical devices, typically made of stainless steel, Tantalum, Platinum or Nitinol alloys, designed to be placed within the inner walls of a lumen within the body of a patient. These stents are typically maneuvered to a desired location within a lumen of the patient's body and then expanded to provide internal support for the lumen. The stents may be self-expanding or, alternatively, may require external forces to expand them, such as by inflating a balloon attached to the distal end of the stent delivery catheter.

The mechanical process of applying a coating onto a stent or other medical device may be accomplished in a variety of ways, including, for example, spraying the coating substance onto the device using gas-assist or ultrasonic atomization, conventional electrospraying, and electrostatic fluid deposition, i.e., applying an electrical potential difference between a coating material and a target to cause the coating material to be discharged from the dispensing point and attracted toward the target by an electric field.

Common to these processes is the need to apply and dry the coating in a manner to ensure that an intact, encapsulated and robust coating of the desired thickness is formed on the stent. Equally important is the need to control coating uniformity and quality (both on the outside coated surface of a substrate and any radial, side-wall surface of a latticed substrate), coating deposition efficiency, and coating droplet or particle size distribution and concentration.

Gas-assist coating methods, such as coating applications utilizing a gas atomization nozzle, have been used to coat medical devices. However, gas-assist coating methods have shown intrinsic problems in adequately controlling coating uniformity and coating quality through the generated coating droplet size distribution and resulting drying time of the coating film, which can affect the kinetic drug release rate in coatings with embedded drug particles. In addition, gas-assist methods delivered by high-velocity gas streams may have low deposition efficiencies (as low as 5%) with either partial or incomplete deposition or excessive overspraying. In other words, generally, only about 5% of the coating material or solution (solvent free basis) that is sprayed from a gas atomization nozzle is deposited on a medical device. The remaining 95% of the coating solution is lost in excessive overspraying and is therefore wasted. Deposition efficiencies are important as the coating materials (the active drug and polymer) have become more expensive, and product processing throughput have become limited by the coating efficiency rate (i.e., the coating process is the bottleneck or critical choke point in throughput processing).

Conventional electrospraying and electrostatic methods have also been used to coat medical devices. For example, in U.S. Pat. No. 6,669,980, filed Dec. 30, 2003, the disclosure of which is hereby incorporated in its entirety by reference, a coating method is described in which a medical device is coated by electrically charged droplets or particles of coating dispensed from a nozzle apparatus. The charged coating material droplets are accelerated by electrostatic attraction from the spray dispenser or nozzle toward the target device. Conventional electrospraying methods can have relatively high deposition efficiency rates (as high as a 60% efficiency rate) and can adequately control coating uniformity and droplet sizing for electrically conductive coating materials or solutions; however, controlling coating droplet sizes and maintaining a stable or robust spray coating process within the well-known “cone-jet” mode can become more difficult with low electrically conducting coating solutions. Conventional electrospraying methods use metal capillary tubes which are electrically conductive and either rely on intrinsic charge carriers or dissociation of ions or electrons in the adequately conductive solution to achieve the desirable coating performance. As a result, conventional electrospraying methods require a coating material or solution with adequate electric conductivity, usually greater than 0.01 μSiemens/cm, which can be achieved through mixture design or conductivity additives (i.e. salts or acids). Conventional electrospraying methods thus may be incompatible with insulative solutions. Using conventional electrospraying methods with electrically insulative solutions can result in a less steady spray plume and reduced droplet or particle size uniformity.

Therefore, there is a need for an improved method and system for coating medical devices such as stents that provides uniform coating application and coating particle sizing, and allows precision control over coating micro-structures and nano-structures with high efficiency when an electrically insulating solution or low electrically conductive solution is used.

### SUMMARY OF THE INVENTION

The present invention is directed to an improved electrospray coating apparatus and method.

In certain embodiments of the invention, there is an apparatus in which the coating material spray dispenser device or nozzle body is made of electrically insulating material and includes an electrically conductive electrode having a proximal end positioned near an orifice in the coating material dispensing device. The medical device to be coated is held at a first electrical potential and a second electrical potential is applied to the electrode in the spray dispenser to inject charge into the adjacent coating material in communication with the electrode via either field emission of electrons or localized field ionization of the coating material, thereby causing the consequently formed coating droplets or coating particles to accelerate toward the medical device from the orifice in the dispensing device. This approach to electrospraying allows an electrically insulative coating material or coating solution below 0.01 μSiemens/cm (along with electrically conductive coating materials or solutions) to be used to coat medical devices, such as metallic stents, because the localized field emission or field ionization can provide sufficient charge carriers necessary for successful electrospraying. The field-injection electrostatic spraying method permits better control of coating uniformity and structure, and coating particle size, thereby permitting enhanced control of kinetic drug release rates.

Additionally or alternatively, in certain embodiments of the invention, the localized field-injection of charge carriers in a coating material may be enhanced by sharpening the proximal end of the electrode to focus and concentrate the electric field strength at the sharpened end.

The present invention eliminates the requirement that the coating possess adequate liquid electrical conductivity for electrospraying; thus permitting a wider range of potential coating materials or solutions for medical devices. Low conductivity coatings can be used to produce medical devices with structures and properties tailored for drug release, among other desired features. For example, medical devices coated with a layer of nanoparticles to provide enhanced controllability of surface morphologies, such as surface porosity, smoothness and thickness, can now be created with low electrically conductive coating materials and solutions. In addition, different structures including fibroid, encapsulated or multiple-layer structures varying in porosity through its thickness may be achieved by modifying the process controls during electrospraying.

The present invention provides better control of coating particle size and kinetic drug release rates, better coating uniformity, and improved deposition efficiency rates for both electrically insulating as well as electrically conductive coating materials and solutions, thus improving coating material transfer to a target in a more cost-efficient manner.

### BRIEF DESCRIPTION OF THE DRAWINGS

FIG. 1 is a schematic view of a first embodiment of a field-injection electrostatic spray coating apparatus in accordance with the present invention.

FIG. 2 is an enlarged schematic view of the field-injection electrostatic spray coating dispensing device and orifice of sectional view “A” from FIG. 1.

### DETAILED DESCRIPTION

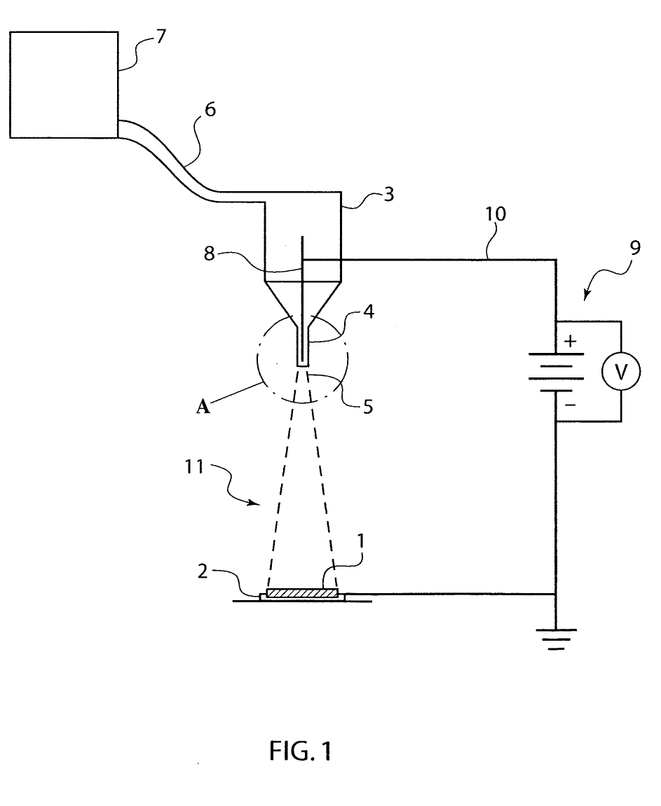

A first embodiment of the present invention is illustrated in FIG. 1. In this embodiment, a medical device 1 to be coated with a coating material is held and positioned by medical device holder 2. Medical device 1 in this instance is a stent that is to be coated with a therapeutic material. Although the medical device shown in FIG. 1 is illustrated as a stent, a variety of types of medical devices may be electrospray coated in the manner disclosed herein. In addition to holding stent 1 in a position suitable for coating application, medical device holder 2 can function as an electrode, and maintain the stent 1 and holder 2 at a first electrical potential. One of ordinary skill in the art would understand that medical device holder 2 may hold medical device 1 by any number of means, such as by the stent holders described in U.S. patent application Ser. No. 10/198,094, the disclosure of which is hereby expressly incorporated by reference herein. In the preferred embodiment, the medical device holder functions as the electrode to maintain the medical device at a first electrical potential to maximize coating deposition efficiency by minimizing masking of the medical device. However, in another embodiment, the medical device itself can be electrically connected at a first electrical potential without the use of holder 2 as an electrode.

The medical device may be designed as a permanent structure to permanently remain within body lumina or vasculature for lasting support. The permanent medical device is designed to be non-biodegradable and non-bioresorbable. Several examples of such permanent structures are coronary stents made from metal, ceramic composite, or polymer materials. Metallic devices may be readily electrically connected at a first electrical potential. Alternatively, the medical device may be made of a nonmetallic conductive ceramic composite or nonmetallic conductive polymer. One of ordinary skill in the art can appreciate that a variety of fasteners, for example, alligator clips, can be used to electrically connect the medical device.

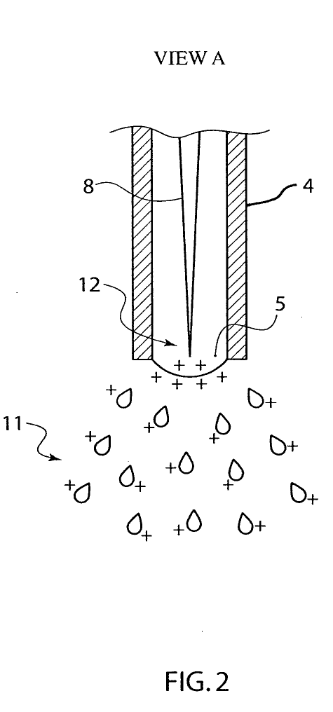

In one embodiment, medical device or stent holder 2 and stent 1 are held at a ground potential during electrospraying of the coating material toward stent 1. Proximate to stent 1 and holder 2 is a field-injection electrostatic spraying system dispensing device 3, schematically illustrated in FIG. 1. Dispensing device 3 includes an electrically insulative dispensing tube 4, with an orifice 5 where the coating material or coating solution can form a meniscus thereabout (shown in FIGS. 1 & 2). Dispensing device 3 fluidly communicates with a coating material reservoir 7 through a coating material supply line 6. An electrode 8, having a proximal end 12 (shown in FIG. 2), is positioned inside dispensing device 3, and is in electrical communication with a voltage source 9 through a wire 10. Voltage source 9 applies a second electrical potential conducted through wire 10 onto electrode 8 via an electrical connection. One of ordinary skill in the art would understand that the wire 10 may be connected to electrode 8 by any electrically conductive means, such as welding or securing with a fastener. For example, the electrical connection may be formed by either welding or fastening the wire 10 to electrode 8 with a conductive metallic nut and plate or flange.

Electrode 8 is made of electrically conductive material, such as tungsten, to carry electrical current. Proximal end 12 of electrode 8 is placed near orifice 5 to locally inject charge into the coating material adjacent the orifice and the meniscus thereabout. In a preferred embodiment, the proximal end of electrode 8 has a sharpened end positioned proximally to orifice 5 and the meniscus thereabout (as shown in FIG. 2) to generate a localized, high-strength electric field. In another embodiment, the sharpened end is a nano-sharpened end, which has a radius of curvature on the order of 1 micrometer at the tip. One of ordinary skill can appreciate that any number of electrically conductive materials can be used to form electrode 8.

Dispensing tube 4 is positioned proximal to medical device 1 and made of an electrically insulative, solvent-resistant material. One example of such a material is glass. A commercially available smooth glass capillary tube may be suitably adapted for use in the present invention with relatively minor modifications. The smooth glass tube minimizes imperfections along the orifice, which may improve particle jet stream stability and uniformity. The sidewall of the electrically insulative dispensing tube 4 enables an electric field to concentrate at the tip of the electrode 8 at proximal end 12 to allow for injecting charge into the insulating coating material or solution between the proximal end 12 and orifice 5 (and the meniscus thereabout). The insulating dispensing tube 4 may have an interior diameter ranging from 50 to 500 micrometers.

Coating material supply line 6 cooperates with dispensing device 3 to supply coating material or coating solution from the coating material reservoir 7 through the dispensing device 3 and dispensing tube 4. The coating material from the reservoir may be supplied to the dispensing device at a flow rate ranging from 1 microliter per minute to 2 milliliter per minute. The coating material forms a meniscus (shown in FIG. 2) around the orifice 5 of dispensing tube 4. The orifice 5 faces the medical device 1 to be coated.

In operation, as the coating material passes through dispensing device 3 and dispensing tube 4 and around electrode 8, electrode 8 is energized by voltage source 9. Electrode 8 receives electrical current from voltage source 9 and creates a high-strength electric field, thereby injecting charge into the surrounding coating material. The coating material is energized by this second electrical potential from the electrode 8 and locally carries charge injected from the tip of electrode 8 to enable electrostatic spraying from the charged meniscus. The charged coating material particles 11 are attracted toward medical device 1, which is being held at a different potential (a first electrical potential) from that of electrode 8. When the charged coating material leaves orifice 5 in the form of fine droplets or particles, the electrical attraction between the coating particles 11 and medical device 1 tends to cause the charged spray particles (shown in FIG. 2) to be attracted to and travel towards medical device 1.

In an alternate embodiment, the electrode 8 has a sharpened end to enhance local charge injection. Surrounded by electrically insulative material in the electrically insulative dispensing tube, the electrically conductive, sharpened electrode, when energized, focuses and concentrates the localized, high-strength electric field at the sharpened tip, thereby injecting charge, via either field emission of electrons or field ionization, into the surrounding coating material adjacent to the orifice 5. Charge injection into the coating material can occur through field ionization, which causes local ionization of the coating material or solution itself, or through field emission, which injects charge through the local emission of electrons from the electrode into the coating material. The sharpened electrode tip improves charge injection into the coating material to enable the formation of charged droplets or particles for electrospraying deposition.

As shown in the enlarged schematic view of dispensing tube 4 in FIG. 2, the electrically conductive, sharpened electrode 8 permits the generation of higher charge densities in the coating material (illustrated as positively-charged particles 11), thereby increasing the electrostatic attraction of the charged coating material particles 11 toward the medical device and reducing coating waste.

Although FIG. 2 illustrates an embodiment with electrode 8 positioned completely within dispensing tube 4, electrode 8 may also be positioned slightly outside dispensing tube 4, extending a distance beyond orifice 5. The diameter of orifice 5 can range from 50 to 500 micrometers.

Because the charge density of the coating material is high due to the localized charge injection into the coating material near the orifice 5, the micron or sub-micron coating material particles 11 each have a relatively high charge state despite their small size. Given their high charge state and low mass, the smaller coating material particles may be more efficiently electrostatically accelerated toward medical device 1 by the electric field, resulting in a higher fraction of the coating material emerging from orifice 5 striking and adhering to medical device 1 than with some conventional gas-assist and electrospraying designs. In addition, improvements in controllability of surface morphology, particle or droplet sizing and coating uniformity can be achieved. Accordingly, a lower fraction of the coating material passes beyond medical device 1, further reducing coating material waste.

Due to the localized mechanism of the charge injection process, a coating material with low electrical conductivity may be deposited onto the medical device. One of ordinary skill in the art can appreciate that a variety of low electrically conductive coating materials can be used. Some such examples include a toluene solution, which has an extremely low conductivity of less than 10⁻¹⁴ S/cm; a methyl ethyl ketone (MEK) solution, which has a conductivity of less than 10⁻⁷ S/cm; and a methyl alcohol solution, which has a conductivity of less than 5×10⁻⁷ S/cm. If the coating material possesses a high electric conductivity, the need for a localized charge injection process may disappear because there may not be any need for injected charge carriers in the highly conductive material. The invention thus allows for a broader range of coating materials which enable accurate control of coating quality and kinetic drug release profiles through enhanced control of the micro-structures and nano-structures of the polymeric coating embedded with the drug in the coating material. One example of a coating material that can benefit from enhanced controllability of kinetic drug release profiles is the polymeric coating Translute, containing embedded Paclitaxel drug particles. The polymeric coating is a mixture of Paclitaxel, Translute and a solvent, along with other additives.

A polymeric coating consisting of several layers with different micro-structures and nano-structures can also be created by adjusting the system parameters in the process of coating each layer. This is primarily because the coating material particles are substantially smaller (0.1 to 100 micrometers) and more monodisperse in the field-injection electrostatic spraying system, enhancing the control over the coating thickness and coverage. This facilitates the coating of multiple layers onto a medical device.

Methods to produce nanodrops and nanoparticles using flow-limited field-injection electrostatic spraying processes have been disclosed in U.S. Pat. No. 5,344,676 to Kim et al., filed Oct. 23, 1992, the disclosure of which is hereby incorporated in its entirety by reference. Also, as described by Berkland, Pack and Kim in Controlling Surface Nano-Structure Using Flow-Limited Field-Injection Electrostatic Spraying (FFESS) Of Poly(D,L-lactide-co-glycolide), published in Biomaterials 25 (2004) 5649-5658, a electrohydrodynamic method of flow-limited field-injection electrostatic spraying has been used to control surface micro-structure and nano-structure to enhance the performance of degradable and bioresorbable devices.

One skilled in the art will appreciate that the separation distance between the orifice 5 of the dispensing tube 4 and medical device 1 varies with the size of the medical device and voltage. Likewise, one skilled in the art will appreciate that the potential difference between electrode 8 and medical device 1 sufficient for efficient transfer of coating material from dispensing tube 4 to medical device 1 varies with the separation distance and size of the medical device. The distance between the orifice and the medical device may be maintained over a broad range, as the voltage difference driving the electrical discharge of coating material toward the medical device may be readily adjusted to ensure the coating material reaches the medical device with a desired coating efficiency.

The voltage may be dialed to a specific electrical potential to control the micro-structure and nano-structure of the coating materials with low electric conductivity. Enhanced control over surface morphology will permit greater control over kinetic drug release and extent of drug release. It also will allow broader coating of various structures with precisely defined micro-structures and surfaces.

To maximize efficient utilization of the coating material with this approach, sufficient electrostatic attraction of the charged coating droplets or particles to the medical device should be provided in order to obtain a high rate of coating deposition, and thus minimize coating waste (i.e., coating that fails to adhere to the medical device). Obtaining sufficient electrostatic attraction between the medical device and the coating material should consist of both good conductivity between the medical device holder and the medical device to ensure the first potential applied to the medical device holder is fully transferred to the medical device, and ensuring the coating material acquires enough charge during its residence time as it passes adjacent the sharpened electrode such that the solution droplets or particles that emerge from the orifice are sufficiently charged to be attracted to the medical device. The result is a higher overall coating deposition efficiency and less undesired waste of coating material.

In an alternate embodiment, multiple-jet electrospray modes can be formed by changing the applied voltage, thereby creating multiple coating material jet streams from a single meniscus. For example, by increasing the electric field strength, the coating material can become highly energized thus creating multiple coating jet streams as the highly charged particles are attracted to the medical device. Other system parameters may be varied for the production of specific types of coating surfaces, such as porous, smooth or woven surfaces. Field-injection electrostatic spraying methods can provide more stable multiple coating jet streams at higher voltages than conventional electrospraying methods because in the former the multiple streams are formed along the coating material meniscus where the surface charge density is highest, instead of (as in the latter) being formed at irregularities or controlled grooves along the orifice perimeter of metal capillary tubes. High-throughput electrospraying similar to that described in U.S. Pat. No. 6,764,720, can be achieved with field-injection electrostatic spraying.

Tailoring and modulating drug release in stents are critical for effective drug uptake and minimization of restenosis. It is suggested that fast drug release rates outside certain desired ranges can be pharmacokinetically ineffective. Too fast a release rate can also result in localized drug retention due to slow diffusion through thrombus near the stent placement area in the vessel. With a field-injection electrostatic spraying system, a polymeric coating consisting of multiple layers with different micro-structures and nano-structures can also be created by adjusting the system parameters in the process of coating each layer. Thus, the multiple coating layered and drug release profiles achieved through a field-injection electrostatic spray process can lead to significant progress in the fabrication of drug-eluting stents and other medical devices.

The therapeutic agent may be any pharmaceutically acceptable agent such as a non-genetic therapeutic agent, a biomolecule, a small molecule, or cells.

Exemplary non-genetic therapeutic agents include anti-thrombogenic agents such heparin, heparin derivatives, prostaglandin (including micellar prostaglandin E1), urokinase, and PPack (dextrophenylalanine proline arginine chloromethylketone); anti-proliferative agents such as enoxaprin, angiopeptin, sirolimus (rapamycin), tacrolimus, everolimus, monoclonal antibodies capable of blocking smooth muscle cell proliferation, hirudin, acetylsalicylic acid, and zotarolimus; anti-inflammatory agents such as dexamethasone, rosiglitazone, prednisolone, corticosterone, budesonide, estrogen, estrodiol, sulfasalazine, acetylsalicylic acid, mycophenolic acid, and mesalamine; anti-neoplastic/anti-proliferative/anti-mitotic agents such as paclitaxel, epothilone, cladribine, 5-fluorouracil, methotrexate, doxorubicin, daunorubicin, cyclosporine, cisplatin, vinblastine, vincristine, epothilones, endostatin, trapidil, halofuginone, and angiostatin; anti-cancer agents such as antisense inhibitors of c-myc oncogene; anti-microbial agents such as triclosan, cephalosporins, aminoglycosides, nitrofurantoin, silver ions, compounds, or salts; biofilm synthesis inhibitors such as non-steroidal anti-inflammatory agents and chelating agents such as ethylenediaminetetraacetic acid, O,O′-bis(2-aminoethyl)ethyleneglycol-N,N,N′,N′-tetraacetic acid and mixtures thereof; antibiotics such as gentamycin, rifampin, minocyclin, and ciprofolxacin; antibodies including chimeric antibodies and antibody fragments; anesthetic agents such as lidocaine, bupivacaine, and ropivacaine; nitric oxide; nitric oxide (NO) donors such as linsidomine, molsidomine, L-arginine, NO-carbohydrate adducts, polymeric or oligomeric NO adducts; anti-coagulants such as D-Phe-Pro-Arg chloromethyl ketone, an RGD peptide-containing compound, heparin, antithrombin compounds, platelet receptor antagonists, anti-thrombin antibodies, anti-platelet receptor antibodies, enoxaparin, hirudin, warfarin sodium, Dicumarol, aspirin, prostaglandin inhibitors, platelet aggregation inhibitors such as cilostazol and tick antiplatelet factors; vascular cell growth promotors such as growth factors, transcriptional activators, and translational promotors; vascular cell growth inhibitors such as growth factor inhibitors, growth factor receptor antagonists, transcriptional repressors, translational repressors, replication inhibitors, inhibitory antibodies, antibodies directed against growth factors, bifunctional molecules consisting of a growth factor and a cytotoxin, bifunctional molecules consisting of an antibody and a cytotoxin; cholesterol-lowering agents; vasodilating agents; agents which interfere with endogenous vascoactive mechanisms; inhibitors of heat shock proteins such as geldanamycin; angiotensin converting enzyme (ACE) inhibitors; beta-blockers; bAR kinase (bARKct) inhibitors; phospholamban inhibitors; protein-bound particle drugs such as ABRAXANE™; and any combinations and prodrugs of the above.

Exemplary biomolecules include peptides, polypeptides and proteins; oligonucleotides; nucleic acids such as double or single stranded DNA (including naked and cDNA), RNA, antisense nucleic acids such as antisense DNA and RNA, small interfering RNA (siRNA), and ribozymes; genes; carbohydrates; angiogenic factors including growth factors; cell cycle inhibitors; and anti-restenosis agents. Nucleic acids may be incorporated into delivery systems such as, for example, vectors (including viral vectors), plasmids or liposomes.

Non-limiting examples of proteins include serca-2 protein, monocyte chemoattractant proteins (“MCP-1) and bone morphogenic proteins (“BMP's”), such as, for example, BMP-2, BMP-3, BMP-4, BMP-5, BMP-6 (Vgr-1), BMP-7 (OP-1), BMP-8, BMP-9, BMP-10, BMP-11, BMP-12, BMP-13, BMP-14, BMP-15. Preferred BMPS are any of BMP-2, BMP-3, BMP-4, BMP-5, BMP-6, and BMP-7. These BMPs can be provided as homdimers, heterodimers, or combinations thereof, alone or together with other molecules. Alternatively, or in addition, molecules capable of inducing an upstream or downstream effect of a BMP can be provided. Such molecules include any of the “hedghog” proteins, or the DNA's encoding them. Non-limiting examples of genes include survival genes that protect against cell death, such as anti-apoptotic Bcl-2 family factors and Akt kinase; serca 2 gene; and combinations thereof. Non-limiting examples of angiogenic factors include acidic and basic fibroblast growth factors, vascular endothelial growth factor, epidermal growth factor, transforming growth factor α and β, platelet-derived endothelial growth factor, platelet-derived growth factor, tumor necrosis factor α, hepatocyte growth factor, and insulin like growth factor. A non-limiting example of a cell cycle inhibitor is a cathespin D (CD) inhibitor. Non-limiting examples of anti-restenosis agents include p15, p16, p18, p19, p21, p27, p53, p57, Rb, nFkB and E2F decoys, thymidine kinase (“TK”) and combinations thereof and other agents useful for interfering with cell proliferation.

Exemplary small molecules include hormones, nucleotides, amino acids, sugars, and lipids and compounds have a molecular weight of less than 100 kD.

Exemplary cells include stem cells, progenitor cells, endothelial cells, adult cardiomyocytes, and smooth muscle cells. Cells can be of human origin (autologous or allogenic) or from an animal source (xenogenic), or genetically engineered. Non-limiting examples of cells include side population (SP) cells, lineage negative (Lin⁻) cells including Lin⁻CD34⁻, Lin⁻CD34⁺, Lin⁻cKit⁺, mesenchymal stem cells including mesenchymal stem cells with 5-aza, cord blood cells, cardiac or other tissue derived stem cells, whole bone marrow, bone marrow mononuclear cells, endothelial progenitor cells, skeletal myoblasts or satellite cells, muscle derived cells, go cells, endothelial cells, adult cardiomyocytes, fibroblasts, smooth muscle cells, adult cardiac fibroblasts+5-aza, genetically modified cells, tissue engineered grafts, MyoD scar fibroblasts, pacing cells, embryonic stem cell clones, embryonic stem cells, fetal or neonatal cells, immunologically masked cells, and teratoma derived cells.

Any of the therapeutic agents may be combined to the extent such combination is biologically compatible.

Any of the above mentioned therapeutic agents may be incorporated into a polymeric coating on the medical device or applied onto a polymeric coating on a medical device. The polymers of the polymeric coatings may be biodegradable or non-biodegradable. Non-limiting examples of suitable non-biodegradable polymers include polystrene; polyisobutylene copolymers and styrene-isobutylene block copolymers such as styrene-isobutylene-styrene tri-block copolymers (SIBS); polyvinylpyrrolidone including cross-linked polyvinylpyrrolidone; polyvinyl alcohols, copolymers of vinyl monomers such as EVA; polyvinyl ethers; polyvinyl aromatics; polyethylene oxides; polyesters including polyethylene terephthalate; polyamides; polyacrylamides; polyethers including polyether sulfone; polyalkylenes including polypropylene, polyethylene and high molecular weight polyethylene; polyurethanes; polycarbonates, silicones; siloxane polymers; cellulosic polymers such as cellulose acetate; polymer dispersions such as polyurethane dispersions (BAYHDROL®); squalene emulsions; and mixtures and copolymers of any of the foregoing.

Non-limiting examples of suitable biodegradable polymers include polycarboxylic acid, polyanhydrides including maleic anhydride polymers; polyorthoesters; poly-amino acids; polyethylene oxide; polyphosphazenes; polylactic acid, polyglycolic acid and copolymers and mixtures thereof such as poly(L-lactic acid) (PLLA), poly(D,L,-lactide), poly(lactic acid-co-glycolic acid), 50/50 (DL-lactide-co-glycolide); polydioxanone; polypropylene fumarate; polydepsipeptides; polycaprolactone and co-polymers and mixtures thereof such as poly(D,L-lactide-co-caprolactone) and polycaprolactone co-butylacrylate; polyhydroxybutyrate valerate and blends; polycarbonates such as tyrosine-derived polycarbonates and arylates, polyiminocarbonates, and polydimethyltrimethylcarbonates; cyanoacrylate; calcium phosphates; polyglycosaminoglycans; macromolecules such as polysaccharides (including hyaluronic acid; cellulose, and hydroxypropylmethyl cellulose; gelatin; starches; dextrans; alginates and derivatives thereof), proteins and polypeptides; and mixtures and copolymers of any of the foregoing. The biodegradable polymer may also be a surface erodable polymer such as polyhydroxybutyrate and its copolymers, polycaprolactone, polyanhydrides (both crystalline and amorphous), maleic anhydride copolymers, and zinc-calcium phosphate.

Such coatings used with the present invention may be formed by any method known to one in the art. For example, an initial polymer/solvent mixture can be formed and then the therapeutic agent added to the polymer/solvent mixture. Alternatively, the polymer, solvent, and therapeutic agent can be added simultaneously to form the mixture. The polymer/solvent/therapeutic agent mixture may be a dispersion, suspension or a solution. The therapeutic agent may also be mixed with the polymer in the absence of a solvent. The therapeutic agent may be dissolved in the polymer/solvent mixture or in the polymer to be in a true solution with the mixture or polymer, dispersed into fine or micronized particles in the mixture or polymer, suspended in the mixture or polymer based on its solubility profile, or combined with micelle-forming compounds such as surfactants or adsorbed onto small carrier particles to create a suspension in the mixture or polymer. The coating may comprise multiple polymers and/or multiple therapeutic agents.

The coating is typically from about 1 to about 50 microns thick. In the case of balloon catheters, the thickness is preferably from about 1 to about 10 microns, and more preferably from about 2 to about 5 microns. Very thin polymer coatings, such as about 0.2-0.3 microns and much thicker coatings, such as more than 10 microns, are also possible. It is also within the scope of the present invention to apply multiple layers of polymer coatings onto the medical device. Such multiple layers may contain the same or different therapeutic agents and/or the same or different polymers. Methods of choosing the type, thickness and other properties of the polymer and/or therapeutic agent to create different release kinetics are well known to one in the art.

The medical device may also contain a radio-opacifying agent within its structure to facilitate viewing the medical device during insertion and at any point while the device is implanted. Non-limiting examples of radio-opacifying agents are bismuth subcarbonate, bismuth oxychloride, bismuth trioxide, barium sulfate, tungsten, and mixtures thereof.

While the present invention has been described with reference to what are presently considered to be preferred embodiments thereof, it is to be understood that the present invention is not limited to the disclosed embodiments or constructions. On the contrary, the present invention is intended to cover various modifications and equivalent arrangements. For example, the coating material may comprise a flowable solid material, such as a powder, in lieu of a fluid, as long as the flowable solid coating material can be reliably fed through the dispensing device and accept a charge imparted by the second potential. The present invention is also suitable for use in a high speed automated medical device coating apparatus. In as much as this invention references dispensed particles, these particles can be in the form of droplets with or without entrained solids at various levels of evaporation. Furthermore, these particles can be dispensed as a solution, a suspension, an emulsion, or any type flowable material as described above.

While the various elements of the disclosed invention are described and/or shown in various combinations and configurations, which are exemplary, other combinations and configurations, including more, less or only a single embodiment, are also within the spirit and scope of the present invention.

What is claimed is:

1. A system for the electrostatic spray application of a coating material onto a medical device, comprising:
a holder for holding a medical device, wherein the medical device is a permanent structure to permanently remain within tissue for lasting support;
a coating material reservoir containing a coating material;
a coating discharge dispensing device formed of an electrically insulating material, wherein the dispensing device is in fluid communication with the reservoir and has an orifice;
an electrode having a proximal end, wherein the proximal end is positioned adjacent the orifice and in communication with the coating material in the dispensing device; and
a means for applying an electrical potential difference between the medical device and the electrode to electrostatically discharge the coating material from the orifice toward the medical device.

2. The electrostatic spray coating system of claim 1 wherein the means for applying an electrical potential difference between the medical device and the electrode is a voltage source.

3. The electrostatic spray coating system of claim 2 wherein the electrode is held at a first electrical potential and the medical device is held at a second electrical potential.

4. The electrostatic spray coating system of claim 1 further comprising:
a coating material conduit having a first end and a second end, wherein the first end is in fluid communication with the coating material reservoir and the second end is in fluid communication with the dispensing device.

5. The electrostatic spray coating system of claim 1 wherein the proximal end of the electrode is adapted to cause localized charge injection into the coating material.

6. The electrostatic spray coating system of claim 5 wherein the proximal end of electrode is sharpened.

7. The electrostatic spray coating system of claim 1 wherein the coating material contains a therapeutic agent.

8. The electrostatic spray coating system of claim 1 wherein the medical device is a stent.

9. A method for electrostatic spray application of a coating material onto a medical device, comprising the steps of:
providing a holder which holds a medical device, wherein the medical device is a permanent structure to permanently remain within tissue for lasting support;
providing a coating discharge dispensing device having an orifice and made of an electrically insulative material;
introducing a coating material into the dispensing device;
positioning an electrode having a proximal end within the dispensing device, wherein the proximal end is positioned adjacent the orifice; and
applying an electrical potential difference between the medical device and the electrode to cause localized charge injection into the coating material in the dispensing device and the coating material to be electrostatically discharged from the orifice toward the medical device.

10. The electrostatic spray coating method of claim 9, wherein the step of applying an electrical potential difference between the medical device and the electrode includes electrically connecting the electrode to a voltage source at a first electrical potential and electrically connecting the medical device at a second electrical potential.

11. The electrostatic spray method of claim 9 wherein the proximal end of the electrode is adapted to cause localized injection of charge into the coating material.

12. The electrostatic spray method of claim 11 wherein the proximal end of the electrode is sharpened.

13. The electrostatic spray coating method of claim 11 wherein the coating material is electrically insulative.

14. The electrostatic spray coating method of claim 9 wherein the medical device is a stent.

15. The electrostatic spray coating method of claim 9 wherein the dispensing device is made of glass.

16. The electrostatic spray coating method of claim 15 wherein the dispensing device includes a smooth glass capillary tube.

17. The electrostatic spray coating method of claim 9 wherein the coating material contains a therapeutic agent.

18. The electrostatic spray coating method of claim 17 wherein the therapeutic agent is selected from the group consisting of paclitaxel, sirolimus, zotarolimus, and everolimus.

19. The electrostatic spray coating method of claim 9 wherein the medical device is made of metallic material.

20. The electrostatic spray coating method of claim 9 wherein the medical device is made of ceramic composite material.

21. A method for electrostatic spray application of a coating material onto a metallic stent, comprising the steps of:
providing a holder which holds a metallic stent;
providing a coating discharge dispensing device having an orifice and made of an electrically insulating material;
introducing a coating material into the dispensing device, wherein the coating material contains paclitaxel;
positioning an electrode within the dispensing device adjacent the orifice, wherein the electrode has a sharpened end; and
applying an electrical potential difference between the metallic stent and the electrode to cause localized charge injection into the coating material in the dispensing device and the coating material to be electrostatically discharged from the orifice toward the medical device.
